(19) United States
(12) Patent Application Publication
(10) Pub. No.: US 2007/0027732 A1
(43) Pub. Date: Feb. 1, 2007

(54) Context-sensitive, location-dependent information delivery at a construction site

(75) Inventor: David W. Hudgens, Alexandria, VA (US)

Correspondence Address: COATS & BENNETT, PLLC, P O BOX 5, RALEIGH, NC, 27602, US

(73) Assignee: Accu-Spatial, LLC

(21) Appl. No.: 11/191,589

(22) Filed: Jul. 28, 2005

(51) Int. Cl. G06F 17/50

(52) U.S. Cl. 705/7

(57) ABSTRACT

A system and method of context-sensitive, location-based information delivery at a construction site senses the identity and current location of each user, and accesses a variety of databases. Based on a user's identity, the status of various tasks associated with the user, and the user's location, the system intelligently accesses only the information that the user needs at his current location at the current time. The system automatically, wirelessly transmits the information to the user, in the most useful format. The system may additionally observe and track the movement of personnel, equipment, and building materials on the construction site, leading to increased productivity through more effective management. The system may also enforce location-based safety codes.

### FIELD OF THE INVENTION

The present invention relates generally to the field of information management and in particular to a system method of delivering context-sensitive, location-based information to users on a construction site.

### BACKGROUND

Modern construction projects involve the collection and dissemination of large amounts of information. This information traditionally takes the form of “blueprints” (e.g., plans, elevations, details, and the like), specifications, materials lists, and the like. Additionally, traditional business information such as project management, human resources, accounting, and the like, must be managed for a successful construction project. The information must be distributed to the relevant person at the appropriate time on the construction site. Traditionally, responsible individuals on the site are armed with an entire subset of information, such as all of the electrical plans and specifications. A user must then sort through this subset of information, to retrieve that which is relevant, such as the electrical plan for a particular room or other specific location on the construction site. In addition to users on the construction site, others may benefit from ease of access to construction information, such as project managers, building inspectors, financial institutions, and the like.

The need for access to much construction site information is task-related. For example, the steel reinforcing bars (“rebar”) in a footing must be inspected prior to pouring concrete into the footing. In this case, the building codes that specify the minimum amount and placement of rebar are only relevant during the time period from when the rebar is installed until the footings are poured. However, construction information is rarely grouped or otherwise discriminated based on scheduling information such as phase of construction or task completion. Rather, individuals must manually sort through large, static collections of information, such as the entire building code, to retrieve the information that is relevant to a particular task.

Safety is an ongoing concern on any construction site, and the management and dissemination of safety-related information is a challenge. For example, OSHA regulations and other codes allow only workers who have received proper training or certification to enter certain areas of the job site, such as an elevated opening. Many such safety regulations are inherently location-dependent, and compliance essentially reduces to managing the location of personnel with respect to dangerous areas. Enforcing compliance with these regulations is difficult, and diverts management and supervisory resources that could be more efficiently deployed in other tasks.

In addition, construction projects make notoriously inefficient use of labor and materials. By some estimates, the labor waste rate (i.e., non-productive time) is as high as 35%, and the materials waste rate is as high as 7%. Much of the labor and materials waste on a construction site results from inefficient control and dissemination of information, as well as a lack of knowledge regarding the location of personnel, equipment, and building materials on the construction site.

### SUMMARY

The present invention relates to a system and method of context-sensitive, location-based information delivery at a construction site. The identity and current location of each user is sensed and relayed to a system comprising a software application running on a controller. The system accesses a variety of databases containing relevant information. Based on a user's identity, the phase of the construction project, the status of various tasks associated with the user, and the user's location, the system intelligently accesses only the information that the user needs at his current location at the current time. The system automatically, wirelessly transmits the information to the user, in the most useful format. The information may comprise text in the user's preferred language; 2-D graphics such as plans, elevations, or details; 3-D graphics such as plumbing or HVAC ducting diagrams; photographs or computer graphic images; audio or video files; or the like.

Each user carries an information appliance. The information appliance may comprise a cellular telephone, a handheld computing device such as a Palm® or Pocket PC®, a tablet computing device comprising a large flat display screen having touch screen or stylus input capability, a laptop PC, or other portable device. Information appliances of varying complexity and capabilities may be selected for each user or class of users, depending on the user's information needs on the construction site. Conversely, the information delivered to a user on a construction site is automatically tailored to the display capabilities of the user's information appliance. In one embodiment, the information appliance comprises a badge that sounds an alarm if the user enters an unauthorized area.

In one embodiment, the present invention relates to a method of delivering context-sensitive information to a user on a construction site. The user is provided with an information appliance. The location of the user is detected. A unique identifier associated with the user detected. One or more databases are accessed and the user's context is establishing. Information is wirelessly downloaded to the user in response to the user's context.

In another embodiment, the present invention relates to a system for delivery of context-sensitive information to users on a construction site. The system includes a controller having a wireless data transfer interface and a database operatively connected to the controller and storing information related to a construction project. The system also includes a plurality of location sensors associated with users and operative to wirelessly transfer to the controller a unique identifier and an indication of location on the construction site. The system additionally includes a plurality of information appliances carried by users, each operative to display context-sensitive information related to the construction project. The information is selected from the database by the controller in response to the unique identifier and the user's location on the construction site, and the information is wirelessly transmitted to each information appliance.

In another embodiment, the present invention relates to a location-based safety system for a construction site. The system includes a controller having a wireless data transfer interface and a database operatively connected to the controller and storing information related to workers on the construction site. The system also includes a location sensor associated with each worker, operative to wirelessly transfer to the controller a unique identifier and an indication of the worker's location on the construction site. The system additionally includes an alarm operative to warn of a location-based safety violation in response to the controller.

### BRIEF DESCRIPTION OF DRAWINGS

FIG. 1 is a functional block diagram of a context-sensitive, location-dependent information delivery system.

FIG. 2 is a functional block diagram of an information system and two construction sites.

FIG. 3 is a functional block diagram of software modules.

FIG. 4 is a flow diagram of the delivery of information to a user at a construction site.

### DETAILED DESCRIPTION

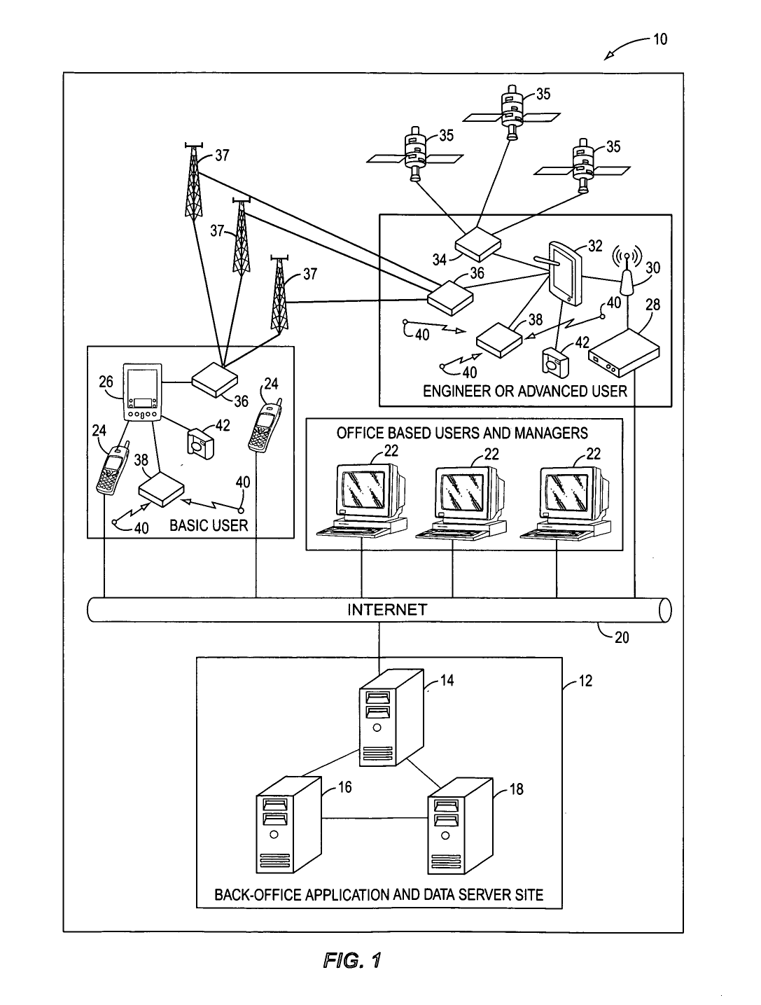

FIG. 1 depicts a high level block diagram of one representative embodiment of the present invention, identified generally by the numeral 10. The system 10 includes one or more servers 14, 16, 18. For example, a server site 12 may house an application web server 14 operatively connected to a geographic information system (GIS) server 16 and a document server 18. As well known in the art, each server 14, 16, 18 may include one or more processors or controller, and one or more databases. The application web server 14 is connected by a high bandwidth data connection to a network 20, such as the Internet. Various users may access the information in databases 16, 18 by Internet-connected PCs 22.

Each user at the construction site carries a location sensor 34, 36, 38 and an information appliance 24, 26, 32 having-wireless connectivity to a server 14, 16, 18 across the Internet 20. For a user 23 having limited information delivery needs, the wireless connectivity to the Internet may be provided via a cell phone 24 accessing a GPRS or CDMA cellular communication system. For a user 25 requiring higher bandwidth or having more sophisticated information delivery needs, the wireless connectivity to the server 14, 16, 18 across the Internet 20 may comprise a modem 28 and a wireless network access point 30. The wireless network may, for example, conform to any of the IEEE 802.11x protocols.

For a basic user 23, an information appliance may comprise a cell phone 24. Alternatively, it may comprise a hand held computer such as a Palm® or Pocket PC® 26, preferably having a wired or wireless (e.g., Bluetooth) connection to a cell phone 24. For a more advanced user 25, the information appliance may comprise a tablet PC 32, a laptop PC, or the like. The sophisticated information appliance 32 connects to the Internet 20 via the 802.11x wireless network access point 30.

In addition to delivering context-sensitive, location-dependent information to users at construction sites, the system 10 may allow users to input information, which is integrated into one or more construction information databases. For example, users may input information into some information appliances 24, 26, 32. Additionally, users may upload digital photographs from digital cameras 42 to document physical aspects of the construction project. The digital cameras 42 may be connected to information appliances 24, 26, 32 by wired or wireless (e.g., Bluetooth) connection.

In the early phases of construction, such as site preparation, a user's location sensor 34 may comprise a global positioning satellite (GPS) receiver 34. The accuracy of the location sensor 34 may be enhanced by the use of Differential GPS (DGPS) or Wide Area Augmentation System (WMS) technologies (not shown).

As construction proceeds, GPS location determination accuracy may degrade or become unusable, as the GPS satellite signals generally cannot penetrate walls, roofs, and floors. In this case, the location sensor 36 may comprise a TV-GPS receiver. TV-GPS is a technology that uses the timing information in broadcast television signals to perform ranging measurements and to calculate location by triangulation, similar to GPS technology. Television signals are designed to penetrate deep into buildings, and offer additional benefits such as frequency diversity by virtue of the large number of channels available.

As another alternative, an indoor location sensor 38 may comprise a directed energy receiver, receiving directed energy signals emitted from location beacons 40 placed in known locations throughout the construction site. Each location beacon 40 emits a unique code or modulation, distinguishing it from all other location beacons 40 at the construction site. In this manner, a location may be uniquely associated with each location beacon 40, and the user's location at the construction site determined by the system 10. In one embodiment, the location beacons 40 comprise active radio frequency identification (RFID) transmitters, and the location sensor 38 comprises an RFID reader. Alternatively, the location beacons 40 may comprise passive RFID transmitters that are powered by an electromagnetic field emitted by the location sensor 38, and that transmit a unique code to the sensor 38 by backscatter modulation.

In another embodiment, the location beacons 40 may comprise acoustic emitters, such as ultrasonic. In still another embodiment, the location beacons 40 may transmit optical energy, such as infrared. In these embodiments, the location sensor 38 comprises a complimentary receiver operative to receive the directed energy from the location beacon 40 and to extract the unique code. In all cases, the location sensor 34, 36, 38 transmits its location (or alternatively, the unique code of one or more location beacons 40) to the server 14, 16, 18. This may comprise transmitting the location information to the user's information appliance 32 by a wired or wireless connection, such as the Bluetooth network. Alternatively, the location sensor 34, 36, 38 may be integrated with the information appliance 26, 32.

Those of skill in the art will recognize that in the case of location sensor 38 and information beacons 40, the location information may flow in the opposite direction. That is, the location sensor 38 may emit an encoded directed energy signal (e.g., RFID, ultrasonic, or infrared). This directed energy signal may be received and decoded by one or more proximate location beacons 40. In this case, the location beacon 40 would then transmit the unique code of the location sensor 38, along with its own identification, to the server 14, 16, 18. At a minimum, the unique identity of the location sensor 38, the unique identity of one or more location beacons 40, and the fact of the proximity of the location sensor 38 to the location beacon 40 must be transmitted to the server 14, 16, 18 for the system 10 to ascertain the user's location on the construction site.

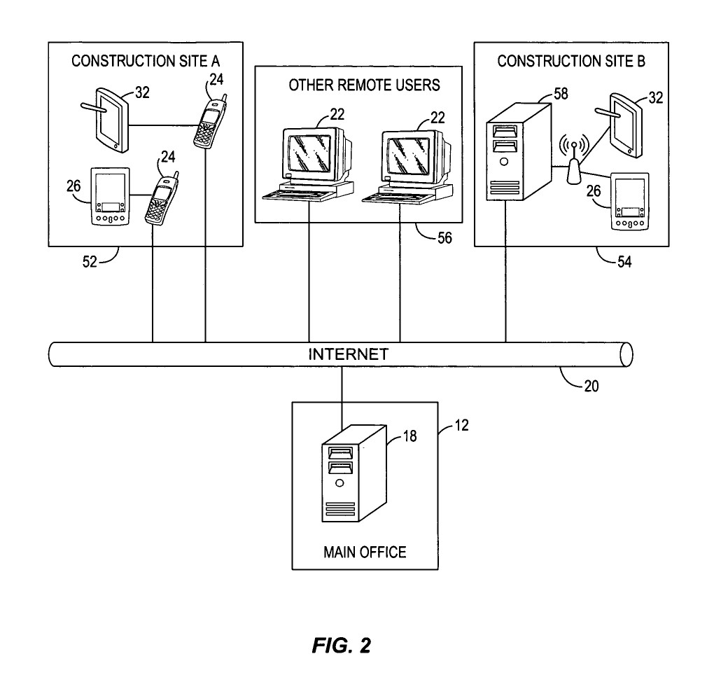

FIG. 2 depicts a representative embodiment of the present invention providing context-sensitive, location-based information delivery for two construction sites. The main office 12 houses the server 18 and associated databases, connected to a data communication network such as the Internet 20. Information is delivered to users at construction site 52, located in an area that enjoys cellular communication system coverage, via GPRS or CDMA wireless networks to cell phones 24. Some cell phones 24 may connect by wired or wireless (e.g., Bluetooth) connection to information appliances 26, 32. In this embodiment, appropriate location sensors 34, 36, 38 are integrated into information appliances 24, 26, 32.

Construction site 54 is located in an area without reliable cellular communication services. Accordingly, information appliances 26, 32 (with integrated location sensors 34, 36, 38) exchange data via a wireless network such as an IEEE 802.11x protocol at access point 30. The wireless network access point 30 may, in some embodiments, be connected to an on-site staging server 58, which is in turn connected to the Internet 20. The staging server 58 may reduce the level of Internet 20 data communication by caching frequently accessed information. Additionally, in some embodiments, the server 18 may pre-load information to the staging server 58 that, based on the phase of construction and status of tasks, it anticipates will be delivered to users at the construction site 54 in the near future.

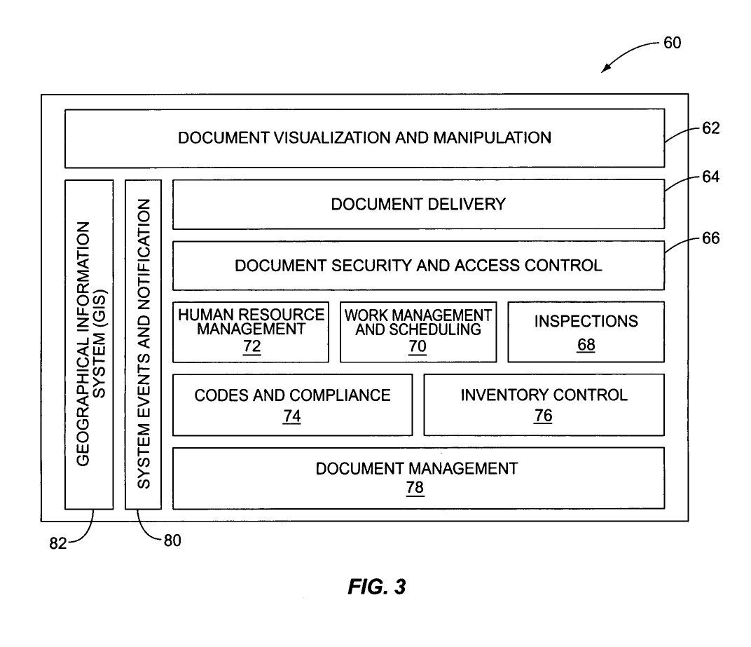

FIG. 3 depicts a software components diagram for the system software 60, according to a representative embodiment of the present invention. A Document Visualization and Manipulation module 62 provides user interfaces. Beneath this are a Document Delivery module 64 and Document Security and Access Control module 66. Beneath these modules is a variety of relational database management modules, including Inspections 68, Work Management and Scheduling 70, Human Resource Management 72, Codes and Compliance 74, and Inventory Control 76. At the heart of the system is a Document Management module 78. Integrated vertically across all of the modules are a System Events and Notifications module 80 and a Geographic Information System module 82.

The Document Visualization and Manipulation module 62 provides user interfaces for the delivery and input of documents and other information. One user interface may comprise a web-based portal for external users, such as subcontractors, architects, and engineers. The web portal may allow authorized users to update documentations, drawings, and details for which they are responsible. Another user interface may comprise a desktop-based or web-based management application for on-site foremen and project managers. This user interface may provide these users with up-to-date information regarding project and task status, as well as statistical information about project progress, to support educated decision-making in the field. Another user interface may comprise a mobile client-based application running on information appliances 24, 26, 32 used by workers at the construction site to view information specific to tasks for which they are responsible.

The Document Delivery module 64 is responsible for using aspects of a worker's skill and trade, and HR information such as the worker's preferred language, to deliver context-specific information to the user's information appliance 24, 26, 32. The Document Delivery module 64 additionally receives information identifying the worker's location, which determines accessible documents that can be retrieved and supplied to the worker.

Access to all documents and electronic files stored in the system is controlled by the Document Security and Access Control module 66. This software subsystem maintains user rights, assignments, and privileges. User may be grouped, and user privileges and access control assigned on a per-group basis. Additionally or alternatively, access control may be managed on individual user accounts. Individual accounts may be aggregated to form groups, and individuals may be added to or removed from groups. Users may be members of more than one group.

The Inspections module 68 is responsible for tracking, recording, and making available for review, all system documents, photographs, building and safety code compliance records, and the like, that may be required to complete an inspection. During inspection, the inspector is provided with relevant documentation, displayed on an information appliance 24, 26, 32, as the inspector moves through the construction site. This location-specific information may include documentation, photographs, construction drawings, and the like. The inspector may additionally enter comments as the inspection proceeds, which are electronically stored.

The Work Management and Scheduling module 70 is responsible for managing the scheduling of tasks required to complete a construction project. Projects comprise a plurality of tasks. Each task has required resources, and may additionally have dependent tasks, which must be completed first. Tasks may have specific construction materials that are required to be delivered and available before the task can begin. Additionally, there may be building and safety code requirements that must be met before the task can be completed. Workers may record completed tasks or progress towards a current task directly, via information appliances 24, 26, 32. This real-time tracking of task and project status allows for more timely and accurate tracking of labor and materials utilization.

The Human Resources (HR) Management module 72 is responsible for the organization and management of all workers at the construction site. The HR module 72 maintains a database of information about each worker, such as medical conditions, work history, job site authority, native language, skill level, safety training and certification, and the like. The HR module 72 additionally may store geographic information about the worker such as his or her current location at the construction site as well as the history of where on the construction site the worker has been and how long he or she was in that area. The worker's location, location histories, current and prior tasks assigned to the workers, and other information may be queried and displayed on a map of the construction site from a management portal. Tracking and storing this information allows for the creation of productivity controls to provide detailed tracking of the amount and type of work actually performed by individuals on the construction site.

The Codes and Compliance module 74 manages building codes and safety codes specific to the construction project and the city, state, or other jurisdictional area that may apply. Building and safety codes may be associated with any information maintained in the system, including documents, electronic files, projects, tasks and specific geographic locations. At any point, a mobile field operator may query the code and compliance module 74 for information about building or safety codes pertaining to the user's current document, work task, or location. In particular, the Codes and Compliance module 74 may intelligently retrieve only the portion of any building or safety code that is relevant to a user's location and the current phase or task status of the construction project. Making this information easily accessible and tailored to a user's location encourages code compliance and facilitates inspection and documentation of that compliance.

The Inventory Control module 76 contains information about building materials and equipment required to complete construction. The Inventory Control module 76 is responsible for tracking the current location of items at the construction site. The module 76 may interact with the System Events and Notifications module 80 to generate messages to alert the relevant workers that material or equipment has arrived at the construction site and the location of the material or equipment. The Inventory Control module 76 may also interact with the Work Management and Scheduling module 70 so that required materials or equipment may be associated with tasks.

The Document Management module 78 is responsible for the management and organization of all construction documentation. The Document Management module 78 provides all necessary functionality for document uploading and document updating, document data and time stamping, document grouping, and document assignment. Documents may be grouped in a variety of ways, including by trade discipline, work skill, and training level. The document grouping method is configurable, allowing new groups to be created at any point with documents assigned to the groups. A key feature of the Document Management module 78 is the ability to store, index, and group documents together using a spatial or geographical property. The geographical property may comprise an absolute location (e.g., longitude, latitude, and altitude) or a proxy for location, such as group number, RFID tag code, construction zone number, or the like. Links to documents may be in the form of Universal Resource Locators (URL), and may access files locally, across a local area network, or across the Internet or other wide area network.

The System Events and Notifications module 80 is responsible for notifying workers of particular information that may be relevant to their current location and/or work task. It may also notify users that relevant documentation in the system has been updated. For example, a worker may be notified that construction materials required for a specific task have arrived at the job site and the location of the materials. As another example, a worker may be notified that a task for which he is responsible is behind schedule. The Systems Events and Notifications module 80 may additionally include a publisher/subscriber architecture, by which users may subscribe to be informed about events that may occur. For example, a user may subscribe to be notified when certain documents or documents within a particular group in the Document Management module 78 have been updated.

The Geographic Information Systems (GIS) module 82 tracks the physical, geographic location of workers, materials, and equipment at the construction site. The GIS module 82 may maintain geographical information in a variety of formats, and may translate a given location between the various formats. The GIS module 82 interfaces with all databases and subsystems within the system 60, to track users, materials, and equipment throughout the construction site, and to tailor information delivery to users at the construction site based on the user's location.

The system software 60 supports the creation, maintenance, and retrieval of construction information in a variety forms. All traditional construction documentation (e.g., plans, elevations, specifications, codes, and the like) are fully supported. Three-dimensional (3D) models are supported. For example, 3D renderings of elements of the construction project may be retrieved and delivered to users' information appliances 24, 26, 32 that support graphic rendering. Additional information appliances (not shown) with native 3D support—such as stereoscopic vision systems, total-immersion Virtual Reality (VR) headsets, 3D volumetric rendering displays, and the like—may be added and deployed, with context-sensitive, location-dependent 3D data being intelligently supplied to such displays as needed.

The system software 60 may additionally support 4D data—in which 3D model data is tied to schedule (time) information—to more effectively analyze and communicate schedule alternatives and their impact on the 3D-modeled building or subsections thereof. The system software 60 may additionally support 5D systems—in which 3D model data and schedule information is tied to financial information—to produce and deliver cost-loaded schedules for financial analysis. In particular, the link between budget and as-built cost expenditure information and the 3D model and schedule information may be particularly attractive and useful to financial institutions. For example, the system software 60 may generate return on investment (ROI) and feasibility studies with an unprecedented level of accuracy, timeliness, and ease of use.

As used herein, the collection of information associated with an individual worker, including that retrieved from the HR Management module 72, is referred to as the worker's “context.” The system of the present invention intelligently selects construction documents for delivery to the user that are particularly relevant to the user based on the user's context and additionally based on other factors such as the known phase or stage of construction, scheduled events or tasks, and the like—i.e., “context-sensitive” information. The body of context-sensitive information may be further discriminated prior to delivery to the user based on the user's location—that is, the information delivered to the user on the construction site is “location-dependent” as well as context-sensitive.

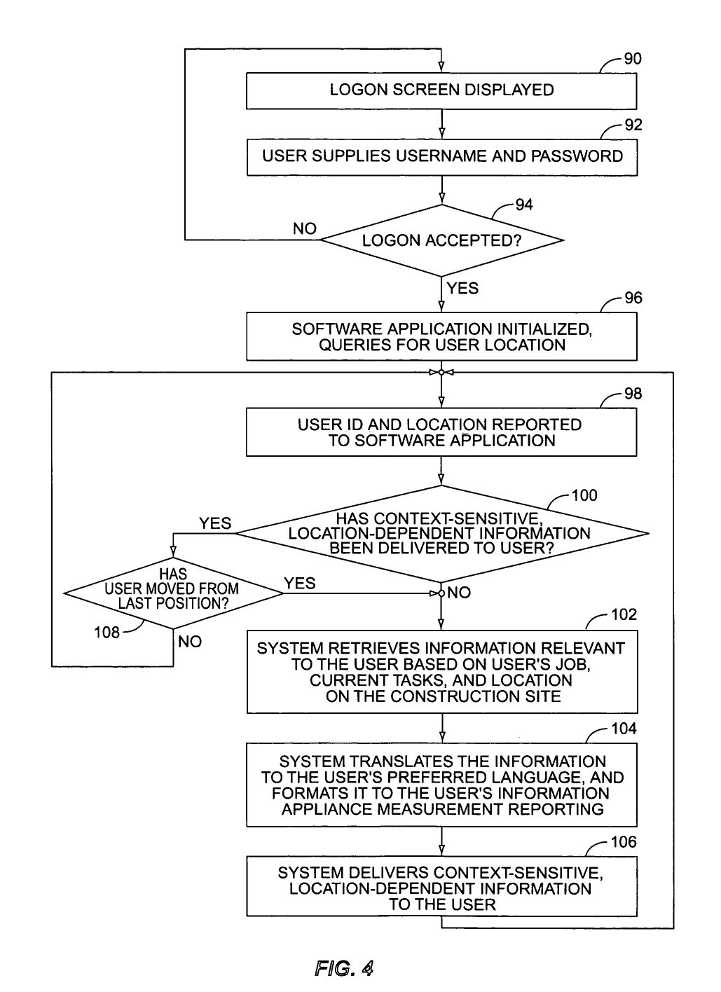

FIG. 4 depicts the delivery of context-sensitive, location-dependent information to a user on a construction site in flow diagram form. When the user arrives at the site and powers up an information appliance 24, 26, 32, a logon screen is displayed (Block 90). The user supplies a previously issued username and password (Block 92) and logs onto the system (Block 94). A software application is initialized, which queries the information appliance 24, 26, 32 for the user's location (Block 96). The user's location sensor 34, 36, 38 detects the user's location on the construction site, and reports this location, along with a unique identifier, to the software system 60 (Block 98). If this is the user's first information request (Block 100), the system retrieves information relevant to the user based on information such as the user's job, current tasks for which the user is responsible, and other information comprising the user's context, as well as the user's location on the construction site (Block 102).

The information retrieved may be translated to the user's preferred language, formatted to the display capabilities of the user's information appliance 24, 26, 32, or otherwise customized to the user (Block 104). The system 60 then delivers the context-sensitive, location-dependent information to the user on the construction site (Block 106). Once information has been delivered to the user (Block 100), the system monitors periodic location reports from the user (Block 98) to determine whether the user has moved from his previous position to a new room, zone, or other area of the construction site (Block 108). If so, the system retrieves information relevant to the user, based on the new location (Block 102), and formats and delivers the updated information (Blocks, 104, 106).

As a non-limiting example of the context-sensitive, location-dependent information delivery systems and method according to one embodiment of the present invention, consider the task of installing tile, in different colors and patterns, in a plurality of rooms, such as the bathrooms of a hotel under construction. Tile arrives at the construction site. The delivery of the tile, and its location, are entered into the system 60 by a foreman via an information appliance 24, 26, 32. Notice to the system 60 of delivery of materials initiates a tile installation task.

The foreman may be sent a list of low-skill workers present on the construction site who are not otherwise engaged in a higher-priority task. The foremen may select one or more workers to stock the relevant rooms with tile. Instructions are then sent to a selected worker's information appliance 24, 26, directing him to where the tile is stored, and specifying which colors of tile are to be delivered to which rooms for installation. In one embodiment, the worker's movement through the construction site may be autonomously monitored, with alerts delivered to the information appliance 24, 26, 32 of a supervisor in the event that the worker strays from the material delivery path, or arrives at a room to deliver tiles following an inordinate delay.

When the system surmises that the tile has been delivered to one or more rooms (such as by noting the tile stocking worker's location in the room), a message may be delivered to the information appliance 24, 26, 32 of a tile installer. The installer may be alerted as to which rooms have been stocked with tile and are otherwise ready for installation to proceed. When the system detects the tile installer in one of the rooms, it may retrieve and deliver to the installer's information appliance 24, 26, 32 the colors and patterns for tile for that particular room.

The installer, in response to a prompt delivered to his information appliance 24, 26, 32, may verify a preceding condition, such as the fact that the proper tile backing material has been installed. The installer may take a digital photograph to document this fact, uploading the photograph to the system via his information appliance 24, 26, 32. The installer may then proceed to install the tile, provided with any additional information automatically by the system.

In one room, the tile installer may note an anomalous condition, such as for example if the plans call for a certain pattern of tile to be installed on a wall, but the installer notices a window in the wall. The tile installer may then “page” a supervisor via his information appliance 24, 26, 32. The supervisor may be alerted, and provided directions to the room where the tile installer is located. Similarly, architects, engineers, or others with the authority to resolve the issue and alter the plans, may be paged and directed to the room. An alternate tile pattern may be discussed and agreed upon, with the architect entering the change through his information appliance 24, 26, 32. This change is then propagated to the Document Management module 78, and notification of the change sent to all relevant parties. Those of skill in the art will readily recognize that virtually all phases or tasks of a construction project (e.g., site preparation, framing, electrical, plumbing, HVAC, dry wall, painting, carpeting, and the like) may advantageously benefit from the context-sensitive, location-based delivery of information to workers, and the ability of authorized individuals to alter construction information directly from the construction site.

In one embodiment, the system 60 comprises a safety code enforcement mechanism. In this embodiment, the location sensor 34, 36, 38 and information appliance 24, 26, 32 may be integrated into a small package with no user interface, such as a badge. In one embodiment, the badge is limited in functionality to the transmission of a unique identifier and a detected location signal. In another embodiment, the badge may additionally include the ability to accept a signal from the system 60 that triggers an alarm such as a buzzer and/or flashing light. In either case, the system 60 may enforce location-based safety codes.

For example, OSHA regulations forbid anyone without “leading edge” training and certification to approach closer than six feet to any ledge or elevated opening, across which a barrier is not erected. According to one embodiment, location beacons 40, having an operative range of six feet, may be placed at or near the opening. Any worker whose badge then transmits the code of a leading edge location beacon 40 may be checked by the system 60 for leading edge certification. If the individual does not have leading edge certification, the system 60 may send a signal to his badge to trigger an alarm. The system may additionally log the safety violation, and take further action, such as directing the individual's supervisor to issue a warning on a first offense, deduct a fine from his paycheck on a second offense, or fire the individual on a third offense. In a similar manner, such a system may enforce access controls for safety, security, and administration purposes throughout the construction site.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of delivering location-based, context-sensitive information to a user on a construction site, comprising:
providing the user with an information appliance;
detecting the location of the user;
detecting a unique identifier associated with the user on the construction site;
accessing one or more databases and establishing the user's context; and
wirelessly downloading information to the user in response to the user's location and context.

2. The method of claim 1 wherein the information appliance comprises at least a display device having a wireless data transfer interface.

3. The method of claim 2 wherein detecting the location of the user on the construction site comprises providing the user with a location sensor operative to receive one or more location signals and further operative to wirelessly transmit information associated with the location of the location sensor.

4. The method of claim 3 wherein the location sensor is integrated into the information appliance.

5. The method of claim 3 wherein the location sensor comprises a satellite positioning system receiver, and the wherein the location signals are satellite positioning system signals.

6. The method of claim 3 wherein the location sensor comprises a directed energy receiver and wherein the location signals are uniquely coded directed energy output by a plurality of location beacons positioned on the construction site.

7. The method of claim 6 wherein the directed energy comprises radio frequency electromagnetic radiation.

8. The method of claim 6 wherein the directed energy comprises acoustic energy.

9. The method of claim 8 wherein the acoustic energy is ultrasonic.

10. The method of claim 6 wherein the directed energy comprises optical energy.

11. The method of claim 10 wherein the optical energy is infrared.

12. The method of claim 6 wherein each uniquely coded location signal is output by a location beacon whose position is known.

13. The method of claim 3 wherein the location sensor is further operative to wirelessly transmit the unique identifier associated with the user.

14. The method of claim 3 wherein wirelessly transmitting information from the location sensor comprises transmitting information via a cellular communication system.

15. The method of claim 3 wherein wirelessly transmitting information from the location sensor comprises transmitting information via a wireless network.

16. The method of claim 14 wherein the wireless network comprises a IEEE 802.11x wireless network.

17. The method of claim 3 wherein the location sensor is further operative to transmit the unique identifier associated with the user.

18. The method of claim 1 wherein establishing the user's context comprises ascertaining the user's job function.

19. The method of claim 1 wherein establishing the user's context comprises ascertaining the user's authority.

20. The method of claim 1 wherein establishing the user's context comprises ascertaining the user's preferred language.

21. The method of claim 1 wherein establishing the user's context comprises ascertaining the user's task relative to the current phase of construction at the site.

22. The method of claim 20 wherein establishing the user's context comprises ascertaining the materials needed by the user.

23. A system for delivery of context-sensitive information to users on a construction site, comprising:
a controller having a wireless data transfer interface;
a database operatively connected to the controller and storing information related to a construction project;
a plurality of location sensors associated with users and operative to wirelessly transfer to the controller a unique identifier and an indication of location on the construction site; and
a plurality of information appliances carried by users and operative to display context-sensitive information related to the construction project, the information selected from the database by the controller in response to the unique identifier and the user's location on the construction site, the information wirelessly transmitted to each information appliance.

24. The system of claim 23 wherein the location sensors are integrated into the information appliances.

25. The system of claim 23 wherein the controller further includes a network interface.

26. The system of claim 25 wherein the database is operatively connected to the controller through a network.

27. The system of claim 26 wherein at least part of the network is the internet and wherein the database comprises at least one domain on the internet.

28. A location-based safety system for a construction site, comprising:
a controller having a wireless data transfer interface;
a database operatively connected to the controller and storing information related to workers on the construction site;
a location sensor associated with each worker, operative to wirelessly transfer to the controller a unique identifier and an indication of the worker's location on the construction site; and
an alarm operative to warn of a location-based safety violation in response to the controller.

29. The system of claim 28 wherein the alarm is integrated into the location sensor.

30. The system of claim 28 wherein the controller is operative to log and report the location-based safety violation.

31. The system of claim 28 wherein the controller identifies each worker by the unique identifier, and accesses that worker's safety training and certification records from the database.

32. The system of claim 31 wherein the controller detects a location-based safety violation if the worker is in a location for which he is not trained or certified.

33. The system of claim 28 further comprising a plurality of location beacons placed at predetermined locations on the construction site, each beacon transmitting a unique location signal.

34. A computer readable medium including one or more computer programs operative to cause a computer to deliver context-sensitive, location-dependent information to a user on a construction site, the computer programs causing the computer to perform the steps of:
detecting the location of the user on the construction site;
receiving a unique identifier associated with the user;
accessing one or more databases and establishing the user's context; and
wirelessly downloading information to the user in response to the user's context.

35. The computer readable medium of claim 34 wherein the computer program includes a Document Visualization and Manipulation module operative to provide and drive user interfaces for the delivery and input of documents and other information.

36. The computer readable medium of claim 35 wherein one user interface is an information appliance carried by the user on the construction site.

37. The computer readable medium of claim 35 wherein one user interface is a web portal.

38. The computer readable medium of claim 34 wherein the computer program includes a Document Delivery module operative to utilize aspects of a worker's skill and trade, HR information, and the worker's location on the job site, to select context-specific, location-dependent information to deliver to the user on the construction site.

39. The computer readable medium of claim 34 wherein the computer program includes a Document Security and Access Control module operative to control access to information maintained by the system.

40. The computer readable medium of claim 39 wherein the Document Security and Access Control module maintains user rights, assignments, and privileges on an individual and group basis.

41. The computer readable medium of claim 34 wherein the computer program includes an Inspections module operative to track, record, and retrieve all information required to complete an inspection on the construction site.

42. The computer readable medium of claim 34 wherein the computer program includes a Work Management and Scheduling module operative to manage the scheduling of tasks required to complete a construction project.

43. The computer readable medium of claim 34 wherein the computer program includes a Human Resources Management module operative to organize and manage information related to each worker at the construction site.

44. The computer readable medium of claim 34 wherein the computer program includes a Codes and Compliance module operative to manage building codes and safety codes having jurisdiction over the construction project.

45. The computer readable medium of claim 34 wherein the computer program includes an Inventory Control module operative to store and manage information about building materials and equipment required to complete a construction project.

46. The computer readable medium of claim 34 wherein the computer program includes a Document Management module operative to store, organize and manage all documentation related to a construction project.

47. The computer readable medium of claim 34 wherein the computer program includes a System Events and Notifications module operative to notify workers of information relevant to their current location and/or work task.

48. The computer readable medium of claim 34 wherein the computer program includes a Geographic Information Systems module operative to track the geographic location of workers, materials, and equipment at a construction site.

49. A method for managing and delivering construction documents that relate to a building being built on a construction site, comprising:
loading construction documents in one or more databases where the construction documents relate to the building or construction site;
grouping the construction documents in the database according to a location criteria such that respective groups of construction documents relate to one or more particular building or construction site locations; and
permitting user access to certain ones of the construction documents based on the location of the user with respect to the building or construction site.

50. The method of claim 49 including further grouping the construction documents in the database according to identity of users; and permitting user access to the construction document based on the location of the user with respect to the building or construction site and the identify of the user.

51. The method of claim 50 wherein grouping the construction documents according to the identify of users is based at least indirectly on the skill or trade of users.

52. The method of claim 49 wherein during the course of constructing the building, permitting users to capture digital images of a portion of the building or construction site, associating a date and a location with the image, and transmitting the image to the database.

53. The method of claim 50 including associating a unique identifier with respect to users; detecting the unique identifier of users as users move about the building or the construction site, and providing access to certain ones of the construction documents based in part at least on the identity of the user.

54. The method of claim 53 including providing respective users with an information appliance.

55. The method of claim 49 including detecting the location of respective users by providing a user with a location sensor operative to receive one or more location signals and further operative to wirelessly transmit information associated with the location of the location sensor.

56. A method of recording information relating to the construction of a building during the course of constructing the building, comprising:
issuing a digital imaging device to one or more users;
during the course of constructing the building, capturing digital images of one or more portions of the building during the construction process;
associating a date and a location with the respective digital images; and
transmitting the digital images to a database that includes construction documents associated with the construction of the building, whereby the digital images in the database provide an ongoing visual record of parts of the building at various stages during the construction process.
